(19) United States
(12) Patent Application Publication
(10) Pub. No.: US 2019/0366941 A1
(43) Pub. Date: Dec. 5, 2019

(54) MOTOR VEHICLE HAVING A DEVICE FOR AIRBORNE SOUND ACOUSTIC SENSING OF THE SURROUNDINGS OF THE MOTOR VEHICLE

(71) Applicant: Robert Bosch GmbH, Stuttgart (DE)

(72) Inventors: Michael Fischer, Niefern-Oeschelbronn (DE); Stephan Berneke, Pforzheim (DE); Jens Koenig, Markgroeningen (DE); Manuel Stoll, Stuttgart (DE); Udo Hermann, Burgstetten (DE)

(21) Appl. No.: 16/476,596

(22) PCT Filed: Nov. 13, 2017
(86) PCT No.: PCT/EP2017/079064

§ 371 Date: Jul. 9, 2019

(30) Foreign Application Priority Data
Jan. 11, 2017 (DE) 10 2017 200 361.8

(51) Int. Cl. B60R 11/02; B60R 11/04; H04R 1/02; H04R 1/04; H04R 1/28

(52) U.S. Cl. CPC B60R 11/0247; B60R 11/04; B60R 2011/0063; H04R 1/04; H04R 1/2853; H04R 1/025

(57) ABSTRACT

The invention relates to a motor vehicle (1) having a device (2) for airborne sound acoustic sensing of the surroundings of the motor vehicle (1), wherein the device (2) comprises at least one microphone (3), which is integrated in a body part (4) or in an attachment part (5) of the motor vehicle (1). According to the invention, at least one opening (6) is formed in the body component (4) or in the attachment part (5) for the entry of sound waves and at least one film (7) or membrane is arranged in the region of the opening (6).

### BACKGROUND OF THE INVENTION

The invention concerns a motor vehicle, wherein the motor vehicle comprises an assembly for airborne sound acoustic sensing of the surroundings of the motor vehicle.

Motor vehicles nowadays are equipped with a number of assistance systems that are primarily used for the safety of the occupants of the vehicle and the other road users. The assistance systems must be supplied with information from the surroundings of the motor vehicle for this purpose, i.e. the surroundings of the motor vehicle must be monitored.

From the published patent application DE 102 34 611 A1, a method for monitoring the surroundings of a motor vehicle is known, with which ambient noise is detected and analyzed. The ambient noise is used as an information source for analysis of the environmental situation of the motor vehicle. When carrying out the method a driver information system is used that is equipped with at least one microphone and with means for assessing the acoustic signals detected by the microphone.

For detecting ambient noise, the microphone must be disposed on the outside of the motor vehicle. I.e. it is exposed to wind and weather and mechanical load by high-pressure cleaners and/or stone strikes. The more exposed the position of the microphone, the greater the risk of damage.

### SUMMARY OF THE INVENTION

It is the object of the present invention to specify an assembly for airborne sound acoustic sensing of the surroundings of a motor vehicle that is integrated within a body component or an attachment part of a motor vehicle and that is also particularly robust. In particular, it is intended to specify an assembly for airborne sound acoustic sensing of the surroundings of a motor vehicle that is protected against the ingress of moisture.

The proposed motor vehicle comprises an assembly for airborne sound acoustic sensing of the surroundings of the motor vehicle with at least one microphone. In this case, the microphone is integrated within a body component or an attachment part of the motor vehicle. I.e. the microphone is disposed externally in relation to the interior of the motor vehicle, thus ensuring that ambient noise can be detected. By integrating the microphone in a body component or an attachment part of the motor vehicle, a certain mechanical protection of the microphone by the body component or the attachment part is already achieved.

According to the invention, it is proposed that at least one opening for the entry of sound waves is formed in the body component or in the attachment part and at least one film or membrane is disposed in the vicinity of the opening. The film or membrane is intended to prevent the entry of dirt and/or moisture through the opening of the body component or the attachment part. The film or membrane is therefore used for protection of the microphone that is disposed behind the film or membrane.

Owing to the film or membrane disposed in the vicinity of the opening in the body component or the attachment part, the robustness of the microphone and hence of the assembly for airborne sound acoustic sensing of the surroundings of the motor vehicle can be increased.

The film or membrane covering at least one opening is preferably fastened to the outside of the body component or to the attachment part. If there is a plurality of openings, each opening can be covered by a film or membrane or a film or membrane covers a plurality of openings at the same time. The fastening to the body component or to an attachment part is intended to prevent removal of the film or membrane. For this purpose the film or membrane is preferably glued to the body component or the attachment part. Furthermore, the gluing is preferably carried out over the entire area.

In a development of the invention it is proposed that the body component or attachment part is completely covered or enveloped by the film or membrane. I.e. the film or membrane forms a type of outer skin of the body component or attachment part, by means of which the body component or attachment part is hermetically sealed. Particularly effective moisture protection is achieved in this way. In addition, no edges or lips are formed that tend to lift or detach, if for example a high pressure water jet is directed at the edge or lip during cleaning of the motor vehicle.

Additionally, it is proposed that an acoustic labyrinth is formed and/or a grid is disposed in the vicinity of the opening of the body component or the attachment part. Although the labyrinth and/or the grid cannot prevent the entry of moisture, they do protect the microphone against mechanical damage.

The assembly for airborne sound acoustic sensing of the surroundings of the motor vehicle advantageously comprises a housing for accommodating the microphone. Owing to the arrangement of the microphone in a housing, the protection of the microphone against external effects is improved further. At least one opening for the entry of sound waves is formed in the housing, wherein the opening is completely covered by at least one film or membrane. The film or membrane can be the film or membrane that is disposed in the vicinity of the opening of the body component or attachment part. It can however also be a further film or membrane that may be covered at least in some areas by the film or membrane that is disposed in the vicinity of the opening of the body component or attachment part. I.e. a plurality of films or membranes can be disposed in a plurality of positions in order to increase the protective effect.

The housing that is used to accommodate the microphone is preferably disposed behind the at least one opening of the body component or attachment part of the motor vehicle. The microphone is therefore doubly protected. In order to enable the unhindered entry of sound waves, the opening in the housing is preferably brought into alignment with the opening in the body component or the attachment part of the motor vehicle. I.e. the opening in the housing is disposed in the vicinity of the opening in the body component or the attachment part.

According to a preferred embodiment of the invention, the housing comprises a collar bounding the opening that engages in the opening of the body component or attachment part. This enables fastening of the housing to the body component or to the attachment part to be achieved at the same time. The outward facing end face of the collar can then act as the contact surface for the film or membrane that covers the opening in the housing.

A cap with at least one opening for the passage of sound waves is preferably disposed on the film or membrane covering the opening in the housing. The cap prevents the film or membrane from detaching from the base at the edges. Furthermore, the cap is preferably joined to the collar of the housing by a plug-in, press-in, clamp, latching, threaded and/or glued joint. This enables the film or membrane to be clamped between the housing and the cap.

Similarly to the opening in the body component or an attachment part of the motor vehicle, alternatively or in addition—an acoustic labyrinth can be formed and/or a grid can be disposed in the vicinity of the opening in the housing in order to further increase the protection of the microphone accommodated in the housing.

The body component can in particular be a mudguard or a windscreen wiper cover. As said body components are usually disposed at exposed points, ambient noise can be optimally recorded.

The attachment part can in particular be an external mirror, a mounting for an external camera, an antenna, a roof rail, a spoiler or a door handle. Such attachment parts comprise a raised position relative to the body of the motor vehicle as a rule, so that a very large ambient region can be monitored.

The at least one opening in the body component or the attachment part is advantageously oriented perpendicularly or obliquely downwards. With a corresponding orientation of the opening the risk that dirt and/or moisture will enter the opening is reduced. Furthermore, the opening is less easily closed as dirt and/or water cannot collect in the vicinity of the opening.

### BRIEF DESCRIPTION OF THE DRAWINGS

Preferred embodiments of the invention are described in detail below using the accompanying drawings. In the drawings:

FIG. 1 shows a perspective representation of an external mirror with an assembly for airborne sound acoustic sensing of the surroundings of a motor vehicle,

FIG. 2 shows a schematic longitudinal section through the assembly of FIG. 1 and

FIG. 3 shows a schematic longitudinal section through a variation of the assembly of FIG. 1.

### DETAILED DESCRIPTION

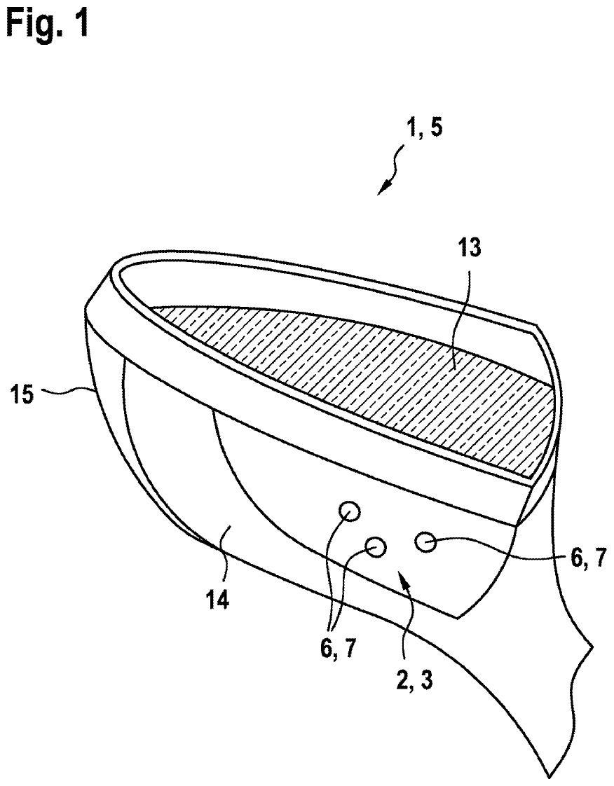

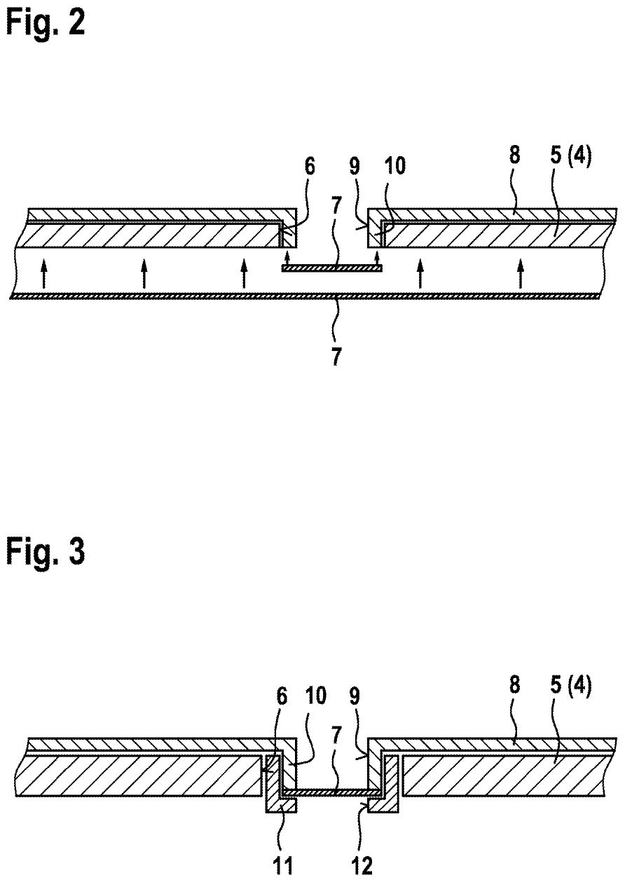

The representation of FIG. 1 shows an attachment part 5 of a motor vehicle 1 with an assembly 2 for airborne sound acoustic sensing of the surroundings of the motor vehicle 1. The attachment part 5 is an external mirror with a mirror 13 that is accommodated in a housing 15. Because the assembly 2 can be integrated not only in an attachment part 5, but also in a body component 4, both reference numbers are stated in the following FIGS. 2 and 3.

The assembly 2 represented in FIG. 1 for acoustic sensing of the surroundings of a motor vehicle 1 comprises three microphones 3 in the present case, which are be disposed behind openings 6 of the attachment part 5. The microphones 3 are accommodated in a housing 8 also comprising openings 9 in the vicinity of the openings 6, so that the sound waves pass through the openings 6 and 9 to the microphones 3 (see FIGS. 2 and 3). The openings 6 and/or 9 are covered by films 7 in order to prevent the entry of dirt and moisture.

The microphones 3 integrated within the attachment part 5 are optimally protected against external effects. On the one hand this is because the housing 8 and the attachment part 5 prevent mechanical damage to the microphones 3. On the other hand a seal is achieved by means of the films 7 disposed in the openings 6, 9. The openings 6, 9 are also disposed on an underside 14 of the attachment part 5, so that dirt deposition is counteracted.

The sectional representation of FIG. 2 shows that the openings 9 in the housing 8 are bounded by a collar 10 that engages in the openings 6 in the attachment part 5 or the body component 4. A first small film 7 is placed on the collar 10. Then a second film 7 can be applied that covers a large area of the region and thus prevents lifting and detachment of the first film. The second film 7 is glued to the attachment part 5 over the entire area for this purpose.

The sectional representation of FIG. 3 shows a modification. Instead of a second film 7, a cap 11 is provided, by means of which the first film 7, which is directly applied to the collar 10, is clamped. The cap 11 is pressed onto the collar 10 for this purpose. The cap 11 thus prevents detachment of the film 7, in particular at the edge thereof. A central aperture 12 in the cap 11 ensures the passage of sound waves.

1. A motor vehicle (1) with an assembly (2) for airborne sound acoustic sensing of surroundings of the motor vehicle (1), wherein the assembly (2) comprises at least one microphone (3) that is integrated within a body component (4) or in an attachment part (5) of the motor vehicle (1), characterized in that at least one opening (6) for entry of sound waves is formed in the body component (4) or in the attachment part (5) and at least one film (7) or membrane is disposed in a vicinity of the opening (6).

2. The motor vehicle (1) as claimed in claim 1, characterized in that the film (7) or membrane is fastened to an outside of the body component (4) or to the attachment part (5).

3. The motor vehicle (1) as claimed in claim 1, characterized in that the body component (4) or the attachment part (5) is completely covered or enveloped by the film (7) or membrane.

4. The motor vehicle (1) as claimed in claim 1, characterized in that an acoustic labyrinth is formed and/or a grid is disposed in the vicinity of the opening (6) in the body component (4) or in the attachment part (5).

5. The motor vehicle (1) as claimed in claim 1, characterized in that the assembly (2) for airborne sound acoustic sensing of the surroundings of the motor vehicle (1) comprises a housing (8) accommodating the microphone (3) and at least one housing opening (9) for the entry of sound waves is formed in the housing (8), wherein the housing opening (9) is completely covered by at least one film (7) or membrane.

6. The motor vehicle (1) as claimed in claim 5, characterized in that the housing opening (9) is disposed in the vicinity of the opening (6) in the body component (4) or the attachment part (5).

7. The motor vehicle (1) as claimed in claim 5, characterized in that a cap (11) is disposed on the film (7) or membrane covering the housing opening (9), the cap comprising at least one opening (12) for passage of sound waves.

8. The motor vehicle (1) as claimed in claim 5, characterized in that an acoustic labyrinth is formed and/or a grid is disposed in a vicinity of the opening (9) in the housing (8).

9. The motor vehicle (1) as claimed in claim 1, characterized in that the body component (4) is a mudguard or a windscreen wiper cover and/or the attachment part (5) is an external mirror, a mounting for an external camera, an antenna, a roof rail, a spoiler or a door handle.

10. The motor vehicle (1) as claimed in claim 1, characterized in that the at least one opening (6) in the body component (4) or the attachment part (5) is oriented perpendicularly or obliquely downwards.

11. The motor vehicle (1) as claimed in claim 1, characterized in that the film (7) or membrane covers the at least one opening (6) and is fastened to an outside of the body component (4) or to the attachment part (5).

12. The motor vehicle (1) as claimed in claim 11, wherein the film (7) or membrane is glued to the body component (4) or to the attachment part (5).

13. The motor vehicle (1) as claimed in claim 5, characterized in that the housing opening (9) is disposed in the vicinity of the opening (6) in the body component (4) or the attachment part (5), wherein a collar (10) bounding the opening (9) in the housing (8) engages in the opening (6) in the body component (4) or the attachment part (5).

14. The motor vehicle (1) as claimed in claim 5, characterized in that a cap (11) is disposed on the film (7) or membrane covering the housing opening (9), the cap comprising at least one opening (12) for passage of sound waves, wherein the cap (11) is joined to the collar (10) of the housing (8) by a plug-in, press-in, clamp, latching, threaded and/or glued joint.
